(19) United States
(12) Patent Application Publication
(10) Pub. No.: US 2009/0207204 A1
(43) Pub. Date: Aug. 20, 2009

(54) Printing apparatus capable of adjusting ink temperature

(75) Inventor: Yoshiyuki Okada, Ibaraki-ken (JP)

Correspondence Address: THE NATH LAW GROUP, 112 South West Street, Alexandria, VA, 22314, US

(73) Assignee: RISO KAGAKU CORPORATION, TOKYO (JP)

(21) Appl. No.: 12/379,151

(22) Filed: Feb. 13, 2009

(30) Foreign Application Priority Data
Feb. 18, 2008 (JP) 2008-036451

(51) Int. Cl. B41J 29/38

(52) U.S. Cl. 347/17; 347/11

(57) ABSTRACT

A printing apparatus is capable of printing images by ejecting ink droplets from nozzles. The printing apparatus includes: a drive signal generation unit which generates ejectable drive pulses for ejecting ink droplets based on image data indicating the number of ink droplets for each pixel, and outputs the ejectable drive pulses to the nozzles; and a temperature measuring unit which measures the temperature of the ink. The drive signal generation unit also outputs non-ejectable drive pulses to the nozzle when the ink temperature is lower than a predetermined temperature. The non-ejectable drive pulses are generated and output in order that even when the nozzle is driven by the non-ejectable drive pulses, no ink droplet is ejected. It is therefore possible to provide, without substantially increasing the production cost, the printing apparatus which can elevate the ink temperature irrespective of the print coverage when the ink temperature is low.

### BACKGROUND OF THE INVENTION

1. Field of the Invention

The present invention relates generally to a printing apparatus capable of adjusting ink temperature.

2. Description of the Background Art

In the case of ink jet printers, warranty temperature ranges are defined to ensure print quality for example as described in Japanese Patent Published Application No. 2004-276486. Because of this, the provision of a heater is proposed in the art for heating ink when the environmental temperature is too low for ink to drop within the warranty temperature range.

This type of an inkjet printer defers the print process until the ink temperature rises to the warranty temperature range, and thereby the print process is delayed by a substantial time required for heating ink when the environmental temperature is low. Particularly, in the case of the ink jet printer making use of circulating ink as described in Japanese Patent Published Application No. 2006-88575, all the ink which is circulating has to be heated, and therefore the time required for heating ink becomes longer than in the case of the ink jet printer making use of ink which is not circulated.

The ink jet printer provided with such a heater prevents the ink temperature from descending below the warranty temperature range by continuing heating the ink even after the ink temperature has reached the warranty temperature range until the ink temperature rises a predetermined temperature. However, the print process can be performed after the ink temperature has reached the warranty temperature range while continuing heating the ink. In the case where the print process and heating of the ink are performed in parallel, the power supply unit of the ink jet printer has to supply both the power required for performing the print process and the power required for heating of the ink.

A high capacity power supply unit can supply sufficient power. However, it increases the production cost. If a small power supply unit is used to keep a lid on cost, it is difficult to concurrently perform the print process and heating of the ink.

When the print process is continuously performed with high print coverages, even if the heater is not energized to heat the ink during the print process, the ink temperature increases due to the heat generated by the ink jet heads which are driven to eject ink. However, if the print coverage is not so high, the ink temperature may not increase. It is therefore conceivable to calculate the print coverage in advance, and energize the heater only when the print coverage is low. However, while there is a power saving advantage, a circuit is needed for calculating the print coverage in addition to a high capacity power supply unit capable of supplying sufficient power to perform the print process and heating of the ink at the same time.

### SUMMARY OF THE INVENTION

Taking into consideration the above circumstances, it is an object of the present invention to provide a printing apparatus capable of elevating the ink temperature irrespective of the print coverage when the ink temperature is low, without substantially increasing the production cost.

In order to accomplish the object as described above, the printing apparatus in accordance with the present invention is capable of printing images by ejecting droplets of ink from an ink ejection mechanism, and comprises: a drive signal generation unit operable to generate ejectable drive pulses for ejecting droplets of the ink on the basis of image data indicative of the number of ink droplets to be ejected for each pixel, and output the ejectable drive pulses to the ink ejection mechanism; and a temperature measuring unit operable to measure the temperature of the ink, wherein the drive signal generation unit generates and outputs, in addition to the ejectable drive pulses for ejecting droplets of the ink, non-ejectable drive pulses to the ink ejection mechanism when the temperature of the ink is lower than a predetermined reference temperature, and wherein the non-ejectable drive pulses are generated and output in order that even when the ink ejection mechanism is driven by the non-ejectable drive pulses, no droplet of the ink is ejected.

Namely, in accordance with the present invention, the ink ejection mechanism can be driven by the non-ejectable drive pulses. Because of this, in the case where the print coverage is high, the ink temperature can be elevated by heat generated by ink ejection operation, and even in the case where the print coverage is low, the ink temperature can also be elevated by heat generated by the non-ejectable drive operation of the ink ejection mechanism. Accordingly, it is possible to elevate the ink temperature, when the ink temperature is low, irrespective of the print coverage. The ink temperature can therefore be elevated without resorting the heater, and thereby it is possible to prevent the cost from increasing due to the power supply unit, which would otherwise be a high power unit. The present invention can effectively be applied to the ink jet printer which employs an ink circulation system provided with an ink circulation route around which the ink to be supplied to the ink ejection mechanism is circulated.

Specifically, in a preferred embodiment, the drive signal generation unit outputs the non-ejectable drive pulses in time slots in which no ejectable drive pulse is output. Also, in a preferred embodiment, the ejectable drive pulses are generated as combination of positive and negative voltage pulses, and the non-ejectable drive pulses are generated as either positive or negative voltage pulses. Furthermore, in a preferred embodiment, even in the case where a heater is provided for heating the ink, the heater halts heating the ink when the non-ejectable drive pulses are output to the ink ejection mechanism. Still further, in a preferred embodiment, the ink ejection mechanism is capable of ejecting a plurality of color inks, and the drive signal generation unit determines whether or not to generate the non-ejectable drive pulses independently for each color ink in accordance with the temperatures of the color inks which may differ.

### BRIEF DESCRIPTION OF THE DRAWINGS

The objects and features of the present invention will become more apparent from consideration of the following detailed description taken in conjunction with the accompanying drawings in which:

FIG. 1 is a schematic diagram for showing the configuration of an ink jet printer in accordance with an embodiment of the present invention.

FIG. 2 is a block diagram for explaining the configuration of the ink flow paths in the inkjet printer in accordance with the embodiment of the present invention.

FIG. 3 is a block diagram showing the configuration of the driver of an ink jet head in accordance with the embodiment of the present invention.

FIG. 4 is a flow chart for showing the flow of the print process in accordance with the embodiment of the present invention.

FIG. 5 is a view for explaining the non-ejectable drive operation when the ink temperature as measured is lower than 25° C. before starting the print process in accordance with the embodiment of the present invention.

FIG. 6A is a view for explaining the conventional relationship between the print coverage and the ink temperature. FIG. 6B is a view for explaining the relationship between the print coverage and the ink temperature in accordance with the embodiment of the present invention.

FIG. 7A is a view for explaining the non-ejectable drive operation repeated for five times in accordance with the embodiment of the present invention. FIG. 7B is a view for explaining the non-ejectable drive operation repeated twice in the first and second time slots followed by the subsequent three time slots without pulses in accordance with the embodiment of the present invention. FIG. 7C is a view for explaining the non-ejectable drive operation by the use of negative voltage pulses in accordance with the embodiment of the present invention. FIG. 7D is a view for explaining the non-ejectable drive operation by the use of negative voltage pulses having a wider pulse width widths in accordance with the embodiment of the present invention.

FIG. 8 is a view for explaining the non-ejectable drive operation performed independently for each ink color in accordance with the embodiment of the present invention.

FIG. 9 is a view for explaining the heating process in the interval between the tasks for printing adjacent print sheets in accordance with the embodiment of the present invention.

### DESCRIPTION OF THE PREFERRED EMBODIMENTS

In the following description, an embodiment of the present invention will be explained in conjunction with the accompanying drawings.

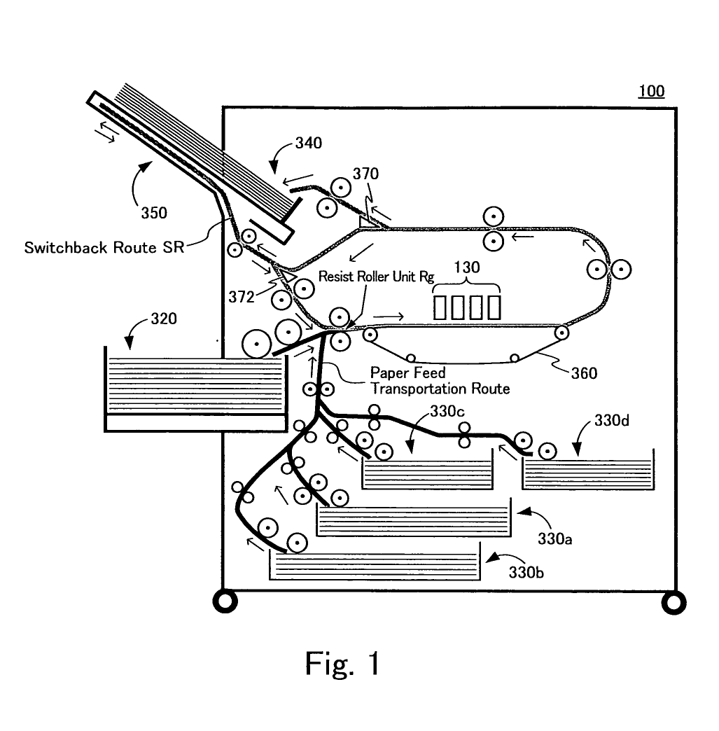

FIG. 1 is a schematic diagram for showing an ink jet printer 100 provided with a circulation transportation route in accordance with the present invention. Particularly, this figure shows the circulation transportation route as a print sheet circulation transportation route. As shown in the same figure, the ink jet printer 100 is provided with a paper feed mechanism for feeding print sheets including a paper feed side tray 320 exposed from the side surface of the housing of the ink jet printer 100, a plurality of paper feed trays 330a, 330b, 330cand 330d which are located inside the housing. Furthermore, a discharge port 340 is provided as a discharge mechanism for discharging print sheets which have been printed.

The line color inkjet printer 100 is provided with a plurality of ink jet heads 130 provided with a number of nozzles as a print mechanism which is elongated in the direction perpendicular to the paper transportation direction, each of inkjet heads 130 serves to eject black or color ink respectively in order to print images of the respective colors on a line-by-line basis. However, the present invention is not limited to a line inkjet printer, but also applicable to other types of printing apparatuses such as a serial color printer capable of forming images by scanning in the line direction.

The print sheet fed from either the paper feed side tray 320 or one of the paper feed trays 330 is transported one after another along a paper feed transportation route (black thick line) by a transportation mechanism such as roller units to a resist roller unit Rg. The resist roller unit Rg is composed of a pair of rollers and provided for defining a reference position at which the leading edge of each print sheet is aligned and oriented. The print sheet which is fed is stopped at the resist roller unit Rg for a short time, and then transferred in the direction toward the print mechanism with a predetermined timing.

There are the plurality of ink jet heads 130 on the transfer direction side of the resist roller unit Rg. The print sheet is printed to form an image with ink ejected from the respective ink jet heads 130 on a line-by-line basis, while being transported at a predetermined speed in accordance with the printer option settings on a conveyor endless belt 360 which is located on the opposite side to the ink jet heads 130.

The print sheet which has been printed is further transported in the housing by the transportation mechanism such as roller units. In the case of one-side printing for printing only one side of the print sheet, the print sheet is transferred directly to the discharge port 340 and stacked on a catch tray 350 as a receiver at the discharge port 340 with the printed side down. The catch tray 350 is provided to protrude from the housing with a certain thickness. The catch tray 350 is slanted with a lower upright wall at which print sheets discharged from the discharge port 340 are automatically aligned under their own weight.

In the case of double-side printing for printing both sides of the print sheet, the print sheet is not transferred to the discharge port 340 just after printing the main side (the first printed side is called “main side”, and the next printed side is called “back side” in this description), but is transported again in the housing. Because of this, the ink jet printer 100 is provided with a shunt mechanism 370 for selectively switching the transfer route for printing on the back side. After printing on the main side, the shunt mechanism 370 transfers the print sheet to a switchback route SR such that the print sheet is reversed with respect to the transportation route by the switchback operation. The print sheet is transferred to the resist roller unit Rg again by the transportation mechanism such as roller units through a switching mechanism 372, and stopped for a short time. Thereafter, the print sheet is transported to the print mechanism with a predetermined timing, and printed on the back side in the same manner as on the main side. After printing on the back side, the print sheet with images printed on the both sides is transferred to the discharge port 340, and stacked on the catch tray 350 serving as the receiver at the discharge port 340.

In the ink jet printer 100, the switchback operation is performed in the double-side printing mode by the use of the space formed in the lower portion of the catch tray 350. The space formed in the catch tray 350 is designed such that the print sheet cannot be accessed externally during the switchback operation. By this configuration, it is avoided that a user extracts the print sheet during the switchback operation by mistake. On the other hand, since the catch tray 350 is indispensable for the ink jet printer 100, there is no need for a separate space, which would be particularly provided in the ink jet printer 100 for the switchback operation, while making use of the space in the catch tray 350 for the switchback operation. Accordingly, it is possible to prevent the size of the housing from increasing for the purpose of implementing the switchback operation. Furthermore, since the discharge port and the switchback route are separated, the paper discharge operation can be performed in parallel with the switchback operation.

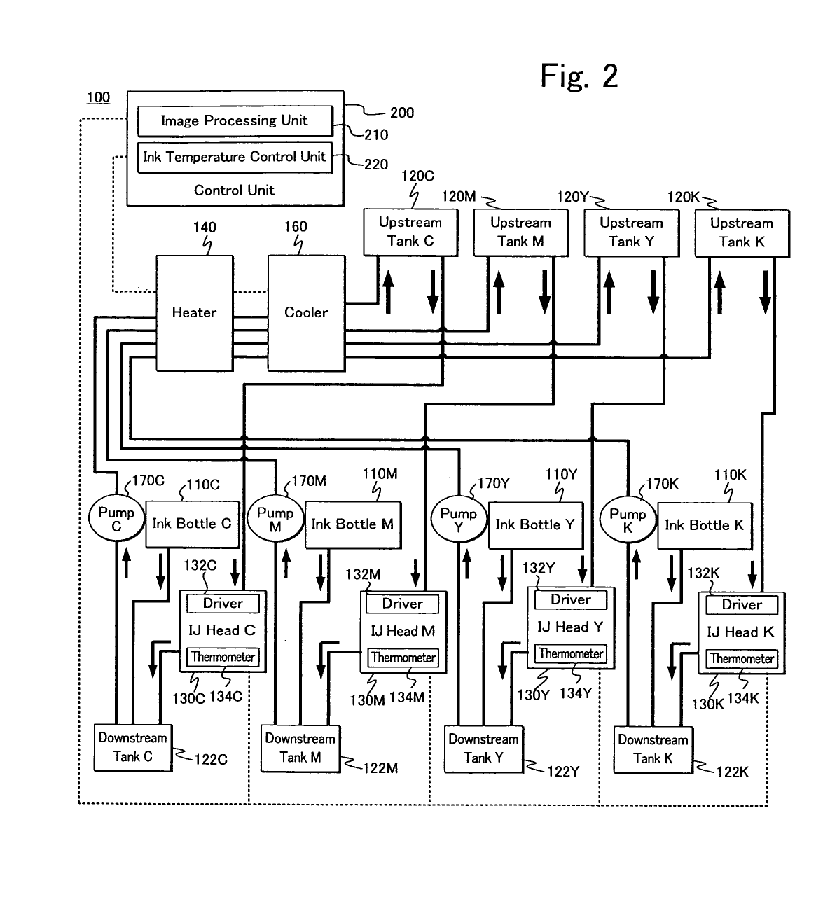

FIG. 2 is a block diagram for explaining the configuration of the ink flow paths in the ink jet printer 100. As shown in the same figure, the ink jet printer 100 is a color printer capable of printing by the use of four color inks C, M, Y and K. The inks of the respective colors are supplied from detachable ink bottles, i.e., an ink bottle 110C for supplying cyan ink, an ink bottle 110M for supplying magenta ink, an ink bottle 110Y for supplying yellow ink, and an ink bottle 110K for supplying black ink.

Also, the ink jet printer 100 is provided with a control unit 200. The control unit 200 is a functional unit of the ink jet printer 100 serving to perform the print process, supply electric power, control the ink temperature and so forth. The hardware of the control unit 200 includes a CPU, a memory and the like. The control unit 200 of the present embodiment is provided with an image processing unit 210 which calculates the ink amount to be discharged for each dot (pixel) of an image on the basis of the print data and outputs the result as image data, and an ink temperature control unit 220 which controls the ink temperature. The ink temperature control unit 220 can output an non-ejectable drive operation setting signal if necessary, as described below.

The ink which is supplied from each of the detachable ink bottles is passed through the flow path formed by a resin or metallic pipe, and stored for a certain period of time in a downstream tank which is located on the downstream side of the ink jet heads 130. Namely, the ink jet printer 100 is provided with a downstream tank 122C for storing the cyan ink, a downstream tank 122M for storing the magenta ink, a downstream tank 122Y for storing the yellow ink, and a downstream tank 122K for storing the black ink. In this description, each of these downstream tanks is generally referred to simply as the downstream tank 122.

The ink stored in the downstream tank 122 is transferred to an upstream tank on the upstream side of the ink jet head 130 by a pump 170. Namely, the ink jet printer 100 is provided with a pump 170C for moving the cyan ink, a pump 170M for moving the magenta ink, a pump 170Y for moving the yellow ink, and a pump 170K for moving the black ink. In this description, each of these pumps is generally referred to simply as the pump 170. Also, the ink jet printer 100 is provided with an upstream tank 120C for storing the cyan ink, an upstream tank 120M for storing the magenta ink, an upstream tank 120Y for storing the yellow ink, and an upstream tank 120K for storing the black ink. In this description, each of these upstream tanks is generally referred to simply as the upstream tank 120. The ink stored in the upstream tank 120 is transferred to the ink jet head provided with a number of nozzles which eject droplets of ink for printing. As shown in this figure, the ink jet heads 130 of the ink jet printer 100 include an ink jet head 130C for ejecting the cyan ink, an ink jet head 130M for ejecting the magenta ink, an ink jet head 130Y for ejecting the yellow ink, and an ink jet head 130K for ejecting the black ink. In this description, each of these ink jet heads is generally referred to simply as the ink jet head 130. In the case of the present embodiment, it is assumed that the inkjet head 130 ejects droplets of ink by the use of piezoelectric elements.

The ink jet head 130 is provided with a driver 132 (132C, 132M, 132Y or 132K) for driving the piezoelectric elements on the basis of the image data transmitted from the control unit 200. Incidentally, the inkjet printer 100 employs an ink circulation system such that the ink remaining in the ink jet head 130 after the print process is returned to the downstream tank 122 through an ink circulation route. The water head difference between the upstream tank 120 and the downstream tank 122 is used to return the ink to the downstream tank 122 from the upstream tank 120 through the ink jet heads 130.

A warranty temperature range is defined to ensure print quality. When the ink temperature drops below this warranty temperature range, the ink has to be heated. Because of this, there is a heater 140 on the ink flow path. The ink temperature control unit 220 serves to control the operation of the heater 140. On the other hand, the driver 132 and the piezoelectric elements generate heat during operation. If the ink temperature rises too high due to heat generation, such as Joule heat and the heat associated with ink vibration, the ink has to be cooled. A cooler 160 is provided for cooling the ink in order not to affect the print process by the generated heat. The ink is passed through the heater 140 and the cooler 160 for controlling the temperature, and then transferred to the upstream tank 120.

Also, the ink jet head 130 is provided with a thermometer 134 (134C, 134M, 134Y, 134K) for directly or indirectly measuring the ink temperature. The ink temperature control unit 220 controls the ink temperature on the basis of the ink temperature measured by the thermometer 134.

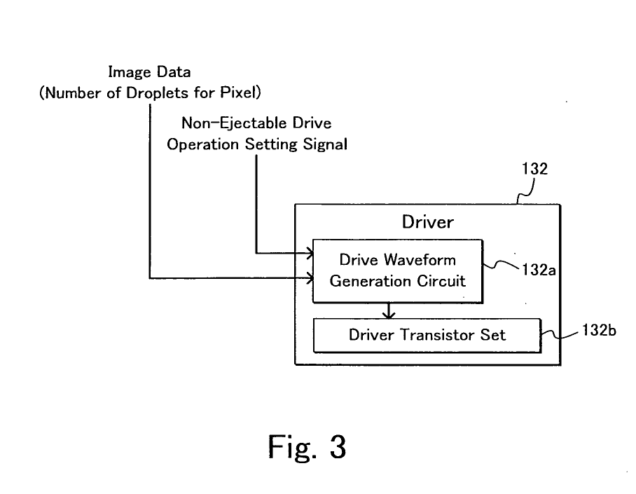

FIG. 3 is a block diagram showing the configuration of the driver 132 of the ink jet head 130. As shown in the same figure, the driver 132 is provided with a drive waveform generation circuit 132a and a driver transistor set 132b. The drive waveform generation circuit 132a serves to generate drive signals having waveforms for driving the piezoelectric elements on the basis of the image data output from the image processing unit 210, and outputs drive signals to the driver transistor set 132b in accordance with the waveforms. The driver transistor set 132b includes a set of driver transistors which apply voltages to the piezoelectric elements on the basis of the drive waveforms output from the drive waveform generation circuit 132a.

In addition to this, the drive waveform generation circuit 132a serves to generate an idling waveform for driving the piezoelectric elements on the basis of the non-ejectable drive operation setting signal which is output from the ink temperature control unit 220, and outputs the idling waveform to the driver transistor set 132b. The idling waveform is prepared in order not actually to eject an droplet as described below.

Incidentally, the image data output from the image processing unit 210 is data indicative of the number of droplets to be ejected for each pixel from each nozzle. In other words, the ink jet head 130 represents a gradation level by the number of droplets, such that a lighter pixel of an image is represented by a smaller number of droplets while a darker pixel of an image is represented by a larger number of droplets. A pixel for which no droplet is ejected is represented by “0” droplet.

In the present embodiment, the warranty temperature range of the ink jet printer 100 is from 20° C. to 45° C. as the ink temperature measured by the thermometer 134. Because of this, when the ink temperature measured by the thermometer 134 is no higher than 20° C., the ink is heated by energizing the heater 140 and circulating the ink in advance of starting the print process. The print process is started after the ink temperature as measured is elevated to 20° C. or higher. However, it should be noted that the specific ink temperatures as described of the present embodiment are only for illustrative purposes.

While the print process started after the measurement of the ink temperature is elevated to 20° C. or higher, the ink has to be continuously heated until the ink temperature is elevated to a predetermined temperature, for example, 25° C., in order to prevents the ink temperature from descending below the warranty temperature range depending on some factors such as the ambient temperature and so forth. In this case, if the ink is continuously heated by the heater 140 after starting the print process, it is required to perform the print process and energize the heater 140 at the same time.

The ink jet heads 130 and the heater 140 are powered by a power supply unit which is not shown in the figure. In the case where the power supply unit is a compact size unit, it is difficult to supply sufficient power to both the ink jet heads 130 and the heater 140, and thereby the ink heating operation by the heater 140 is substantially restricted. In the case of the present embodiment, therefore, the following control is performed in place of heating the ink by the heater 140.

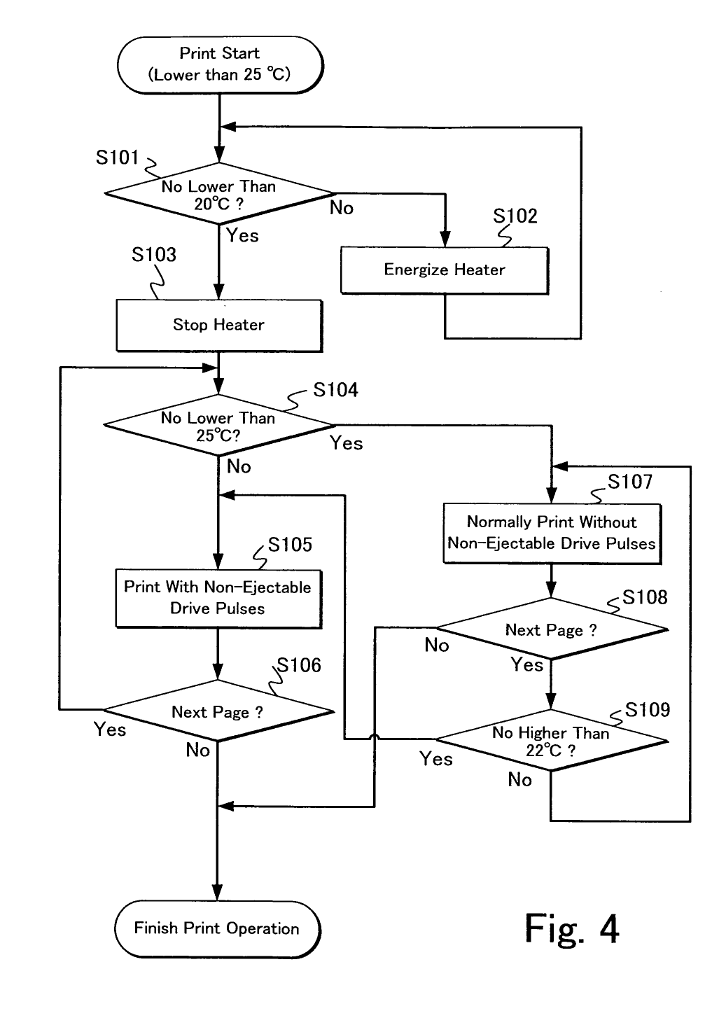

FIG. 4 is a flow chart for showing the process flow in accordance with the present embodiment. This flow chart is applicable when the ink temperature as measured is lower than 25° C. before starting the print process. In this case, first, it is determined whether or not the ink temperature as measured is no lower than 20° C. which is the lower limit of the warranty temperature range in step S101. As a result, if the ink temperature as measured is lower than 20° C. (i.e., the “No” branch from step S101), the ink is heated by the heater 140 in step S102. At this time, the ink is circulated by the pump 170. The actual print process is not started, while continuously heating the ink, until the ink temperature as measured reaches 20° C.

When the ink temperature as measured is no lower than 20° C. or is elevated to 20° C. (i.e., the “Yes” branch from step S101), the ink is not heated by the heater 140, or the power supply to the heater 140 is halted in step S103.

Then, it is determined whether or not the ink temperature as measured is no lower than 25° C. which is the predetermined temperature in step S104. As a result, if the ink temperature as measured is lower than 25° C. (i.e., the “No” branch from step S104), the print process is started as well as non-ejectable drive operation for the purpose of elevating the ink temperature in step S105.

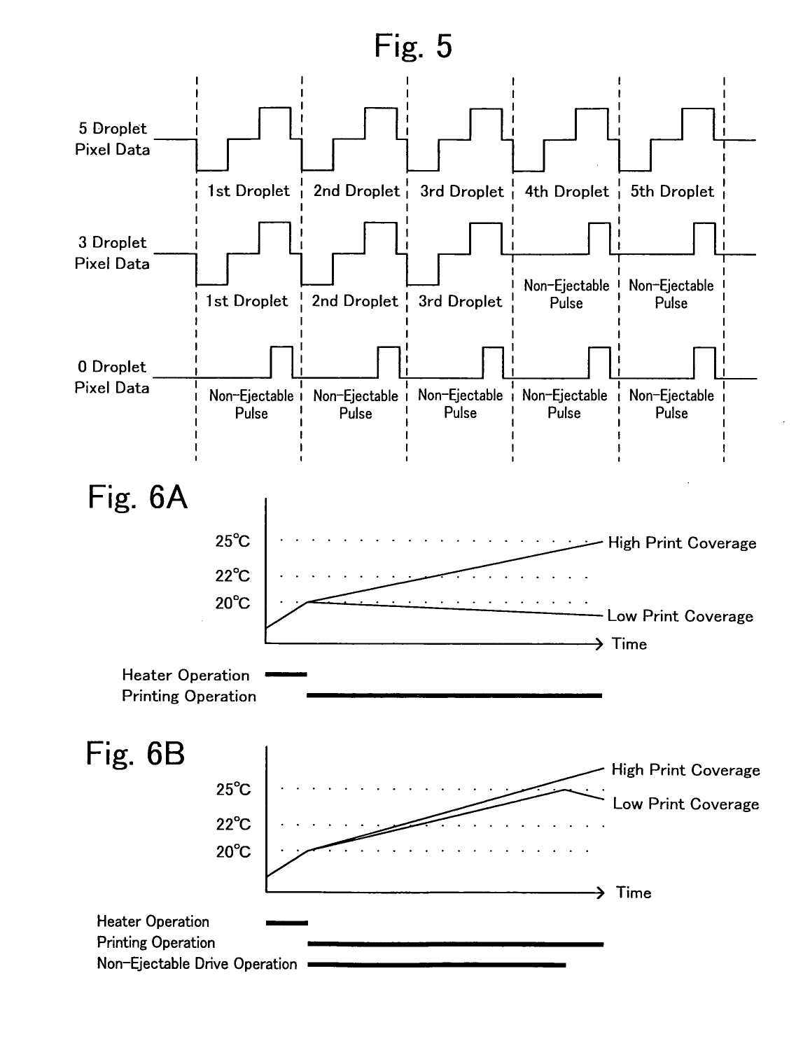

This non-ejectable drive operation will be explained with reference to FIG. 5. Generally speaking, in the print process of the ink jet printer, one droplet is ejected by applying a negative voltage pulse and a positive voltage pulse as a pair to the piezoelectric element. The negative voltage pulse serves to expand the ink chamber, and the positive voltage pulse serves to contract the ink chamber. Accordingly, as illustrated in FIG. 5 for example, this pulse pair is repeatedly applied for five times to the piezoelectric element used to eject ink to the pixel having a gradation level of five droplets. The non-ejectable drive operation is not performed for the purpose of ejecting ink but performed for the purpose of driving the piezoelectric element in order not actually to eject ink. For example, the non-ejectable drive operation can be performed by applying only either one of the negative voltage pulse and the positive voltage pulse. Of course, as long as the piezoelectric element is driven in order not to eject the ink, the voltage pulse for the non-ejectable drive operation can have any waveform and magnitude.

Heat can be generated by performing the non-ejectable drive operation because the driver 132 and the piezoelectric element are driven irrespective of the print coverage. In addition to this, the vibration of ink can also generate heat. The ink can be heated by the heat as generated, and therefore it is possible to elevate the ink temperature irrespective of the print coverage without resorting the heater 140.

Namely, in the case where the print coverage is high, the ink temperature can be elevated by heat generated by ink ejection operation. But, even in the case where the print coverage is low, the ink temperature can also be elevated by heat generated by the non-ejectable drive operation. In this case, since the non-ejectable drive operation is not associated with ink ejection, the quality of the print image is not affected by this non-ejectable drive operation. Also, since the ink can be heated at the same time as the print process is performed, it is possible to start the print process just after the ink temperature as measured has reached the lower limit of the warranty temperature range. By this configuration, the waiting time for starting the print process can be substantially reduced.

In the case of the present embodiment, the non-ejectable drive operation is performed for each nozzle in timeslots in which no droplet is to be ejected. For example, in the case where one nozzle can eject a maximum of five droplets for each pixel in five time slots respectively, when the nozzle ejects droplets to the pixel having a gradation level of three droplets, no droplet is ejected in the fourth and fifth time slots as illustrated in FIG. 5. The non-ejectable drive operation is performed in the fourth and fifth time slots. Incidentally, since the nozzle ejects no droplet to the pixel having a gradation level of “0” droplet through all the five time slots, the non-ejectable drive operation is performed for five times. Alternatively, the non-ejectable drive operation maybe performed only for the “0” droplet pixels such that the drive waveform generation circuit 132a can easily control the ink spray operation.

More specifically speaking, the ink temperature control unit 220 determines whether or not to perform the non-ejectable drive operation in accordance with the ink temperature as measured by the thermometer 134, and outputs the non-ejectable drive operation setting signal to the drive waveform generation circuit 132a of the driver 132 when the non-ejectable drive operation is to be performed. The drive waveform generation circuit 132a receives the non-ejectable drive operation setting signal, and generates the drive signal for the non-ejectable drive operation in the time slots in which no droplet is ejected in accordance with the number of droplets indicated by image data.

Returning to FIG. 4, when one page is completely printed by the print process associated with the non-ejectable drive operation in step S105, it is determined in step S106 whether or not there is a next page to be printed. If there is not a next page to be printed (i.e., the “No” branch from step S106), the print process is finished. Conversely, if there is a next page (i.e., the “Yes” branch from step S106), it is determined whether or not the ink temperature as measured is no lower than 25° C. in step S104. If the ink temperature as measured is lower than 25° C. (i.e., the “No” branch from step S104), the print process is repeatedly performed in step S105 while the non-ejectable drive operation is performed in association for the purpose of elevating the ink temperature.

Conversely, when the ink temperature as measured is no lower than 25° C. (i.e., the “Yes” branch from step S104), it is no longer needed to elevate the ink temperature, and thereby the normal print process without the non-ejectable drive operation is started in step S107. When one page is completely printed by the print process without the non-ejectable drive operation in step S107, it is determined in step S108 whether or not there is a next page to be printed. If there is not a next page to be printed (i.e., the “No” branch from step S108), the print process is finished.

Conversely, if there is a next page (i.e., the “Yes” branch from step S109), it is determined whether or not the ink temperature as measured drops no higher than a predetermined temperature, e.g., 22° C. in step S108. Even when the ink temperature as measured is elevated to 25° C. at a certain time, the ink temperature as measured may drop no higher than 20° C. depending upon the ambient temperature or other factors. In order to avoid this shortcoming, it is detected when the ink temperature as measured drops no higher than the predetermined temperature, e.g., 22° C. Needless to say, the predetermined temperature is not limited to 22° C., but can be set to a temperature between the lower limit of the warranty temperature range and the temperature at which the ink temperature has no longer to be elevated.

When the ink temperature as measured is higher than 22° C. (i.e., the “No” branch from step S109), the print process is repeatedly performed in step S107 without the non-ejectable drive operation on the assumption that the ink temperature has no longer to be elevated. On the other hand, when the ink temperature as measured drops to 22° C. or a lower temperature (i.e., the “Yes” branch from step S109), the print process is performed in step S105 while performing the non-ejectable drive operation.

By performing the non-ejectable drive operation as described above, in the case of the present embodiment, it is possible to elevate, when the ink temperature is low, the ink temperature irrespective of the print coverage. In the case of a conventional ink jet printer without performing the non-ejectable drive operation, when the ink temperature is too low, ink is heated to 20° C. by a heater followed by halting energization of the heater and starting the print process. Thereafter, if the print process is performed with a high print coverage, the ink temperature can be maintained to be sufficiently high. However, if the print process is performed with a relatively low print coverage, the ink temperature drops from 20° C., as illustrated in FIG. 6A.

Contrary to this, in the case of the ink jet printer 100 of the present embodiment as has been discussed above, when the ink temperature is too low, the ink is heated to 20° C. by the heater followed by halting energization of the heater and starting the print process. Thereafter, the ink temperature can be maintained to be sufficiently high whether the print coverage is high or low, as illustrated in FIG. 6B. When ink temperature rises beyond 25° C., the non-ejectable drive operation is halted so that the ink temperature may start dropping. However, when the ink temperature drops as low as 22° C., the non-ejectable drive operation is resumed so that the ink temperature can be elevated again.

Meanwhile, the drive waveform for driving the piezoelectric element during the non-ejectable drive operation is not limited to the waveform as illustrated in FIG. 5. For example, for “0” droplet pixels, the nozzle may be driven by the drive waveform shown in FIG. 7B containing only two pulses for the non-ejectable drive operation in the first and second time slots and no pulse in the third to fifth time slots, in place of the drive waveform shown in FIG. 7A containing five pulses for the non-ejectable drive operation in all the five time slots. Alternatively, the number of pulses for the non-ejectable drive operation in the five time slots can be adjusted in accordance with the ink temperature as measured and other factors. For example, when the ink temperature is substantially low, the number of pulses for the non-ejectable drive operation in the five time slots is set to a larger number, e.g., as many as possible such that all the piezoelectric elements are driven in all the five time slots. Conversely, when the ink temperature rises high, the number of pulses for the non-ejectable drive operation in the five time slots is set to a smaller number.

Also, it is possible to use a drive waveform containing negative voltage pulses for the non-ejectable drive operation as illustrated in FIG. 7C. Irrespective of the polarity of pulses, the pulse width can be adjusted depending upon the ink temperature or the like. For example, the pulse width W1 shown in FIG. 7C may be changed to the wider pulse width W2 shown in FIG. 7D in order to enhance the elevation of the ink temperature.

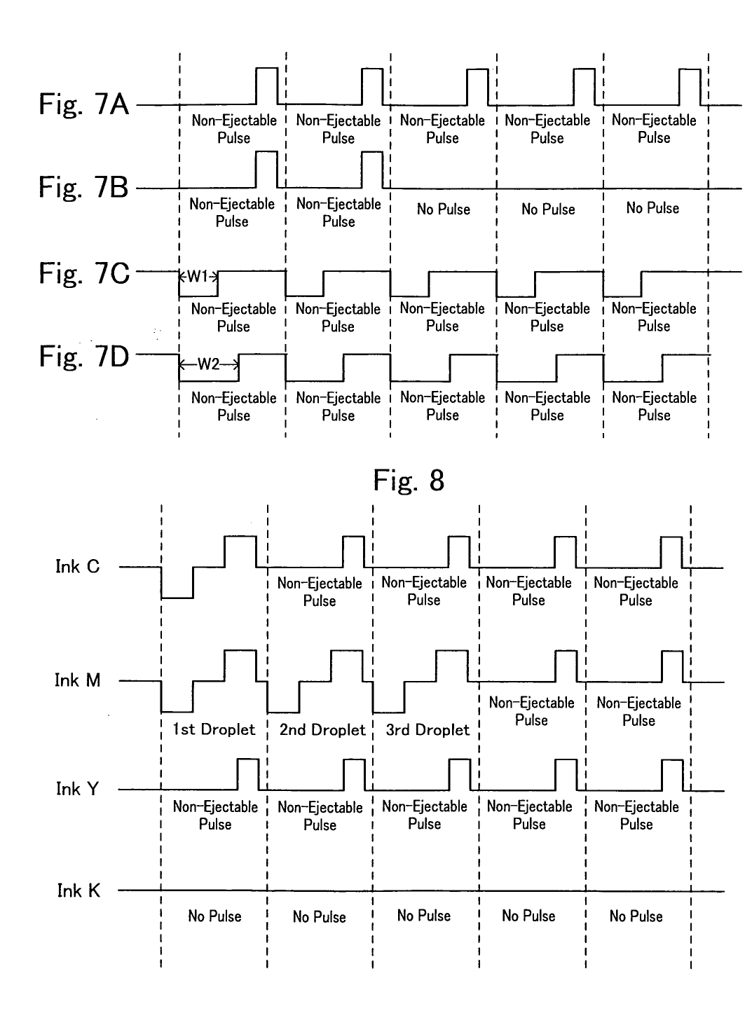

The non-ejectable drive operation can be performed independently for each ink jet head 130. For example, in the case where black-and-white images are continuously printed, the temperature of black (K) ink may rise high while the temperatures of the other inks (C, M, Y) drop low. In this case, as illustrated in FIG. 8, the non-ejectable drive operation is not performed for black ink, but is performed for the other inks (C, M, Y) to heat only the low temperature inks. This process can be performed by performing the procedure shown in FIG. 4 independently for each color ink.

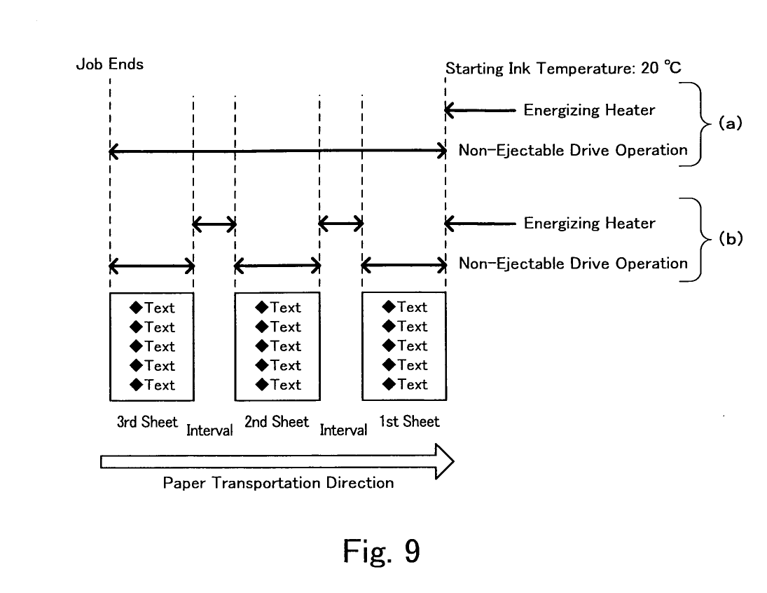

The non-ejectable drive operation can be performed not only during performing actually printing a print sheet, but also in the interval between the tasks for printing adjacent print sheets, in the interval between adjacent print jobs, in a stand-by mode, and so forth. For example, it is possible to energize the heater to heat the inks before starting the print process and thereafter to perform the non-ejectable drive operation continuously during actually printing each print sheet and in each interval the tasks for printing adjacent print sheets until all the print jobs are completed as the schedule (a) of FIG. 9. Alternatively, it is possible to energize the heater to heat the inks in the interval between the tasks for printing adjacent print sheets as the schedule (b) of FIG. 9.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as a resulted to the particular use contemplated.

What is claimed is:

1. A printing apparatus capable of printing images by ejecting droplets of ink from an ink ejection mechanism, comprising:
a drive signal generation unit operable to generate ejectable drive pulses for ejecting droplets of the ink on the basis of image data indicative of the number of ink droplets to be ejected for each pixel, and output the ejectable drive pulses to the ink ejection mechanism; and
a temperature measuring unit operable to measure the temperature of the ink,
wherein the drive signal generation unit generates and outputs, in addition to the ejectable drive pulses for ejecting droplets of the ink, non-ejectable drive pulses to the ink ejection mechanism when the temperature of the ink is lower than a predetermined reference temperature, and
wherein the non-ejectable drive pulses are generated and output in order that even when the ink ejection mechanism is driven by the non-ejectable drive pulses, no droplet of the ink is ejected.

2. The printing apparatus as claimed in claim 1 wherein
the drive signal generation unit outputs the non-ejectable drive pulses in time slots in which no ejectable drive pulse is output.

3. The printing apparatus as claimed in claim 1 wherein
the ejectable drive pulses are generated as combination of positive and negative voltage pulses, and the non-ejectable drive pulses are generated as either positive or negative voltage pulses.

4. The printing apparatus as claimed in claim 1 further comprising a heater operable to heat the ink,
wherein the heater halts heating the ink when the non-ejectable drive pulses are output to the ink ejection mechanism.

5. The printing apparatus as claimed in claim 1 wherein
the ink ejection mechanism is capable of ejecting a plurality of color inks, and wherein
the drive signal generation unit determines whether or not to generate the non-ejectable drive pulses independently for each color ink.

6. The printing apparatus as claimed in claim 1 further comprising an ink circulation route around which the ink to be supplied to the ink ejection mechanism is circulated.
